(19) United States
(12) Patent Application Publication
(10) Pub. No.: US 2004/0060414 A1
(43) Pub. Date: Apr. 1, 2004

(54) Food processing appliance

(75) Inventor: Jarl Sundqvist, Sollentuna (SE)

Correspondence Address: ALFRED J MANGELS, 4729 CORNELL ROAD, CINCINNATI, OH, 452412433

(73) Assignee: AB Hallde Maskiner, Kista (SE)

(21) Appl. No.: 10/663,890

(22) Filed: Sep. 16, 2003

(30) Foreign Application Priority Data
Sep. 17, 2002 (SE) 0202759-7

(51) Int. Cl. B26D 1/12

(52) U.S. Cl. 83/663; 83/932

(57) ABSTRACT

A food processing appliance, such as a food slicing or a food dicing machine, that includes aluminum components, such as cutting discs that include knives and/or food dicing gratings, and feeders that come into contact with the food being processed, wherein the aluminum components being made in die cast aluminum. After being cast, cleaned and possibly treated, an aluminum component is tumbled so as to obtain a dense surface. The tumbled component is coated with the aid of a chemical nickel plating process, wherein the chemically applied coating has a thickness exceeding 5 μm.

### BACKGROUND OF THE INVENTION

1. Field of the Invention

The present invention relates to a food processing appliance, such as a food slicing or a mincing/dicing machine. Appliances of that type include aluminum components, such as knife-carrying, disc-shaped cutters and/or food infeed means that come into contact with the food being processed.

2. Description of the Related Art

A vegetable processor is an example of such an appliance, i.e., an appliance for cutting and subdividing greens and root vegetables. Such individual vegetable processors are used in large-scale kitchens and restaurants to process greens and root vegetables.

A known processor of that type is described in U.S. Pat. No. 3,468,355. The appliance is constructed to include a feeder comprised of a vertically upstanding cylindrical tube and a food infeed device in the form of a plate disposed at right angles to the longitudinal axis of the tube. The plate can be displaced in the tube, either manually or by drive means. The plate can also be swung away form the upper orifice of the tube to allow the green vegetables, or root vegetables, that are to be processed to be fed into the tube. A cutting implement, or a cutting implement combination comprising a disc equipped with one or more knives, is located at the lower orifice of the tube. The knives, or cutters, may be disposed horizontally or at an angle to the horizontal plane. As the disc rotates and the contents of the feeder are pressed down against the cutting implement, the implement functions to subdivide the contents, after which the subdivided contents pass down through openings in the cutting implement by the movement of the knives. The cutting implement is encased in a knife housing.

Other cutting appliances exist in which the cutting implement consists of a rotatable knife-equipped disc.

These known discs, and also the feeder and knife housing, are machine components which are often produced from die cast aluminum, where the alloy EN AB 44300 (ASTM 413) is typical in that regard. That alloy contains silicon. Subsequent to being cast, the machine components are polished to a bright and dense surface structure with the aid of steel balls.

If the machine components are washed in a dishwasher using a dishwashing detergent typical in respect of large-scale kitchens, the silica present in the alloy will be precipitated onto the surfaces of the discs in the form of a coating of black silicon dioxide. That silicon dioxide precipitate transfers quite readily to the fingers of the person preparing the food and also to the food itself. Moreover, the discs do not give the impression of being clean. As a result, the discs are washed manually, thereby avoiding such precipitation.

Since the discs, feeder, and knife housing need to be washed frequently, the necessity of washing those components manually is a significant drawback.

That problem is overcome by means of the present invention, which provides aluminum components and other components that can be washed in a dishwasher with no deleterious effect on the components.

### SUMMARY OF THE INVENTION

The present invention thus relates to a food processor, such as a food slicing or dicing appliance, that includes aluminum components, such as cutting discs that include knives, and/or feeders that come into contact with the food being processed. The aluminum component is made from die cast aluminum, and after being cast it is cleaned and possibly treated. The aluminum component is tumbled so as to obtain a dense surface, and the component is then coated with the aid of a chemical nickel plating process, wherein the chemically applied coating has a thickness exceeding 5 μm.

### BRIEF DESCRIPTION OF THE DRAWING

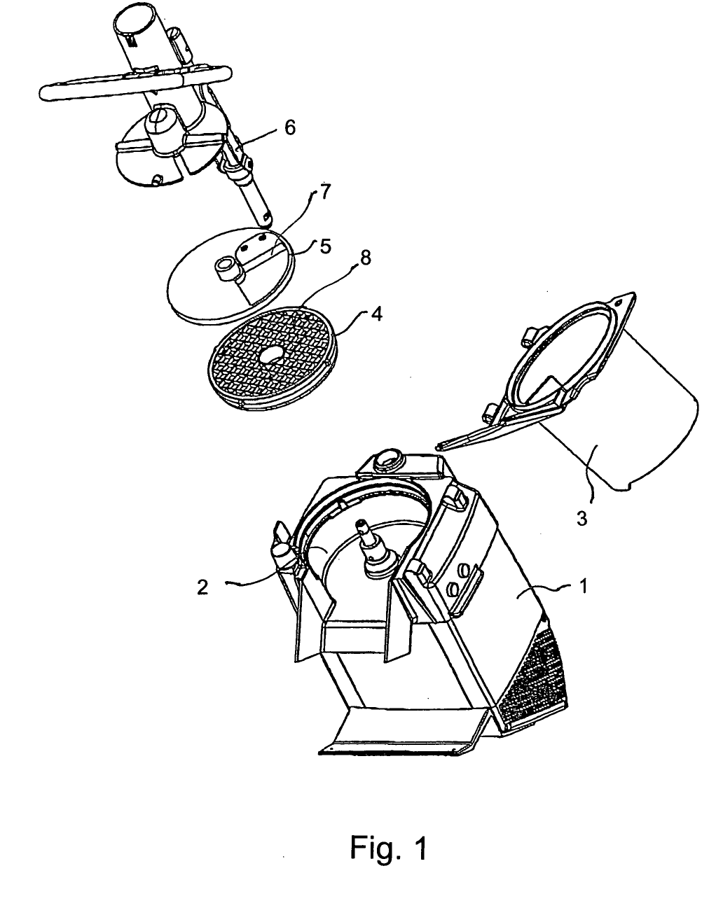

The invention will now be described in more detail partly with reference to the accompanying drawing, in which FIG. 1 is an exploded view of one example of a cutting appliance.

### DESCRIPTION OF THE PREFERRED EMBODIMENTS

The present invention relates to a food processor, such as a food slicing, food dicing/mincing or subdividing appliance, including aluminum components, such as knife-carrying cutting discs and/or feeders that come into contact with the food being processed, wherein the components are made from die cast aluminum.

After having prepared the food ingredients in the processor, it is necessary to wash the cutting discs, feeders, and knife housings by hand. The present invention enables these aluminum components to be washed in a dishwasher in the absence of any negative effect.

In FIG. 1, the numeral 1 identifies a machine housing, the numeral 2 identifies a knife housing, the numeral 3 identifies a feed cylinder, the numeral 4 identifies a dicing grating, the numeral 5 identifies a cutting disc, and the numeral 6 identifies a feed plate. The cutting disc 5 includes radially extending knives or cutters 7 and the dicing grating includes vertical knives or cutters 8. When adapted in accordance with the present invention, all of those components can be washed in a dishwasher, with the exception of the machine housing 1.

Depending upon the type of machine concerned, many other components made in accordance with the invention can be washed in a dishwasher. Accordingly, those components shown in FIG. 1 are only examples of components that can be produced in accordance with the invention. Thus, aluminum components other than those mentioned above are included within the present invention.

After having been cast, cleaned, and possibly treated, the aluminum component according to the invention is tumbled so as to obtain a dense surface, and is then nickel-plated chemically to a thickness in excess of 5 μm.

According to one preferred embodiment, the tumbling process is effected with the aid of ceramic grinding bodies. That results in a compressed and smooth surface suitable for the chemical application of a nickel layer. The tumbling process is carried out for a period of from 5 to 10 minutes.

A chemical nickel plating process involves immersing the component in a bath that contains typically a nickel-phosphorus solution. No electric current is used. The composition of the layer applied will depend on the composition of the bath.

According to a highly preferred embodiment of the invention, the chemical nickel plating process is carried out in accordance with a method designated ENPLATE@. That method and its components are the products of Enthone Incorporated, USA, for example of Enthone's Eastern Plant, West Haven, Conn., USA.

### EXAMPLE

There now follows an example of the treatment to which a tumbled aluminum component is subjected in accordance with the invention.

In a first process step, the component is degreased by dipping the same into a weak alkaline etching bath.

In a second process step, etching is carried out in CANDOETS AL NR: 1 for a period of 1 (one) minute.

In a third process step, etching is carried out in SALTSYRABET for a period of 45 seconds. The bath contains nitric acid, sulfuric acid, and ammonium hydrogen fluoride.

In a fourth step, a zincate coating is applied in ZINCATBET over a period of 20-45 seconds. That results in the current-less precipitation of zinc as a metal coating substrate. That treatment provides oxide protection.

In a fifth step, etching is carried out in SUR STRIP until the zincate coating has disappeared. The bath contains nitric acid, hydrochloric acid, and ammonium hydrogen fluoride.

In a sixth step, a zincate coating is applied over a period of 10-20 seconds, in the same way as that used in the fourth process step. That sixth step results in a fine structure that enhances the adhesion of a nickel layer.

In a seventh process step, a nickel layer is applied in a bath containing KEMINICKEL ENPLATE AL-100. The aluminum components are nickel plated in the bath in the absence of electric current.

In an eighth step, which is the last process step, the aluminum components are treated chemically in a nickel-plating bath at a high phosphorous concentration, in the absence of electric current. The treatment is designated ENPLATE Ni-425 and is carried out over a period of about 1.5 hours.

The above mentioned designations “CANDOETS AL NR: 1”; “SALTSYRABET”; “ZINKATBET”, “SURSTRIP”, “KEMINICKEL ENPLATE AL 100,” and “ENPLATE Ni-425, are designations used by the nickel plating plant Brink AB in Norrköping, Sweden. The process gives good corrosion resistance, high wear resistance, low friction, and a layer of uniform thickness. The process also provides the aluminum components with relatively bright and attractive surfaces.

Moreover, the applied layer prevents silicon from penetrating out onto the surfaces of the components when washed in a dishwasher, thereby also preventing the formation of the above-mentioned silicon oxide layer.

According to another preferred embodiment, the applied layer has a thickness greater than 10 μm. That gives the aluminum components a useful life span of at least some years.

The present invention thus provides a solution to the problem mentioned in the introduction.

The present invention is not concerned with the process per se and hence the process is not described in any great detail herein. Neither is the invention limited to its application in respect of aluminum components that are treated in accordance with the above process steps, since other chemical nickel plating processes can be applied. The present invention can thus be varied.

The present invention should therefore not be considered to be limited to the above-described embodiments, since variations can be made within the scope of the accompanying claims.

What is claimed is:

1. A food processing appliance component that comes into contact with food being processed, the component being formed from die cast aluminum, said component comprising: a dense outer surface provided by tumbling the component, and after tumbling the component is coated with the aid of a chemical nickel plating process wherein the chemically applied coating has a thickness exceeding 5 μm.

2. An appliance component according to claim 1, wherein the tumbling is effected with the aid of ceramic grinding bodies.

3. An appliance component according to claim 1, wherein the chemically applied coating has a thickness greater than 10 μm.

4. An appliance component according to claim 1, wherein the chemically applied coating is carried out in accordance with a method designated ENPLATE@.

5. An appliance component according to claim 1, wherein the component is a cutting disc that includes radially extending knives.

6 An appliance component according to claim 1, wherein the component is a feed housing that includes a feeder plate for feeding ingredients into contact with a cutting element.

7. An appliance component according to claim 1, wherein the component is a knife housing that surrounds a cutting member.

8. An appliance component according to claim 1, wherein the component is a combination of a cutting disc and a dicing grating that includes vertical knives.

9. A method for minimizing the formation of a black silicon dioxide coating and aluminum component subjected to dishwashing detergents, said method comprising the steps of:
a) tumbling the components to provide thereon a dense outer surface; and
b) plating the tumbled component with a nickel coating having a thickness exceeding 5 μm.

10. A method in accordance with claim 9, wherein the tumbling is effected with the aid of ceramic grinding bodies.

11. A method in accordance with claim 9, wherein the chemically applied coating has a thickness greater than 10 μm.

12. A method in accordance with claim 9, wherein the chemically applied coating is carried out in accordance with a method designated ENPLATE@.

13. A method in accordance with claim 9, wherein the component is a cutting disc that includes radially extending knives.

14. A method in accordance with claim 9, wherein the component is a feed housing that includes a feeder plate for feeding ingredients into contact with a cutting element.

15. A method in accordance with claim 9, wherein the component is a knife housing that surrounds a cutting member.

16. A method in accordance with claim 9, wherein the component is a combination of a cutting disc and a dicing grating that includes vertical knives.
